(19) United States
(12) Patent Application Publication
(10) Pub. No.: US 2018/0114367 A1
(43) Pub. Date: Apr. 26, 2018

(54) COMPUTER-READABLE RECORDING MEDIUM, IMAGING CONTROL METHOD, AND INFORMATION PROCESSING APPARATUS

(71) Applicant: FUJITSU LIMITED, Kawasaki-shi (JP)

(72) Inventor: Hiroshi Kuwabara, Suginami (JP)

(73) Assignee: FUJITSU LIMITED, Kawasaki-shi (JP)

(21) Appl. No.: 15/691,981

(22) Filed: Aug. 31, 2017

(30) Foreign Application Priority Data
Oct. 20, 2016 (JP) 2016-206386

(51) Int. Cl. G06T 19/00; G06T 1/20

(52) U.S. Cl. CPC G06T 19/006; H04N 21/4223; G06T 1/20

(57) ABSTRACT

A non-transitory computer-readable recording medium stores therein an imaging control program that causes a computer to execute a process including: acquiring imaging condition, upon detection that a reference object is included in a captured image taken by a camera, the imaging condition being associated with identification information of the detected reference object by referring to a storage that stores a plurality of imaging conditions in association with pieces of identification information of a plurality of reference objects respectively; determining whether the captured image is corresponding to the acquired imaging condition; and outputting, when the imaging condition is corresponding to the acquired imaging condition, an instruction to the camera to capture another image.

### CROSS-REFERENCE TO RELATED APPLICATION

This application is based upon and claims the benefit of priority of the prior Japanese Patent Application No. 2016-206386, filed on Oct. 20, 2016, the entire contents of which are incorporated herein by reference.

### FIELD

The embodiment discussed herein is related to a computer-readable recording medium, an imaging control method, and an information processing apparatus.

### BACKGROUND

In recent years, there is a case where workers at a field site carry a head mounted display (hereinafter, “HMD”) and a terminal device, and work while referring to operating instructions, manuals, or the like. Further, there has been proposed a system that an assistant who assists workers uses an information processing apparatus connected to terminal devices of the workers via a network to share captured images taken by an HMD or the terminal devices and to issue operating instructions. At this time, for example, in a construction work where insertion and pulling out of a cable are performed, there is a case of confirming whether the cable as a work object is the right cable, by transmitting a captured image of a tag attached to the cable to the assistant.

Patent Document 1: Japanese Laid-open Patent Publication No. 2015-167349

Patent Document 2: Japanese Laid-open Patent Publication No. 2015-022737

### SUMMARY

According to an aspect of an embodiment, a non-transitory computer-readable recording medium stores therein an imaging control program that causes a computer to execute a process including: acquiring imaging condition, upon detection that a reference object is included in a captured image taken by a camera, the imaging condition being associated with identification information of the detected reference object by referring to a storage that stores a plurality of imaging conditions in association with pieces of identification information of a plurality of reference objects respectively; determining whether the captured image is corresponding to the acquired imaging condition; and outputting, when the imaging condition is corresponding to the acquired imaging condition, an instruction to the camera to capture another image.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of an imaging control system according to an embodiment;

FIG. 2 is a diagram illustrating an example of an imaging-condition storage unit;

FIG. 3 is a diagram illustrating an example of an extraction range of a captured image;

FIG. 4 is a flowchart illustrating an example of an imaging control process according to the embodiment;

FIG. 5 is a flowchart illustrating an example of the imaging control process according to the embodiment; and

FIG. 6 is a diagram illustrating an example of a computer that executes an imaging control program.

### DESCRIPTION OF EMBODIMENT

However, because characters written on the tag are small, if zooming of a camera is adjusted to the maximum setting, camera shake or head shake is caused to make it difficult to capture an image in which characters can be read. Therefore, in order to acquire a captured image in which the tag can be read, workers need to perform an imaging operation several times, and thus capturing the tag image may impose workload on the workers.

Preferred embodiments of the present invention will be explained with reference to accompanying drawings. The disclosed techniques are not limited to the embodiments. These embodiments described below may be combined with each other as appropriate within a scope in which no contradiction occurs.

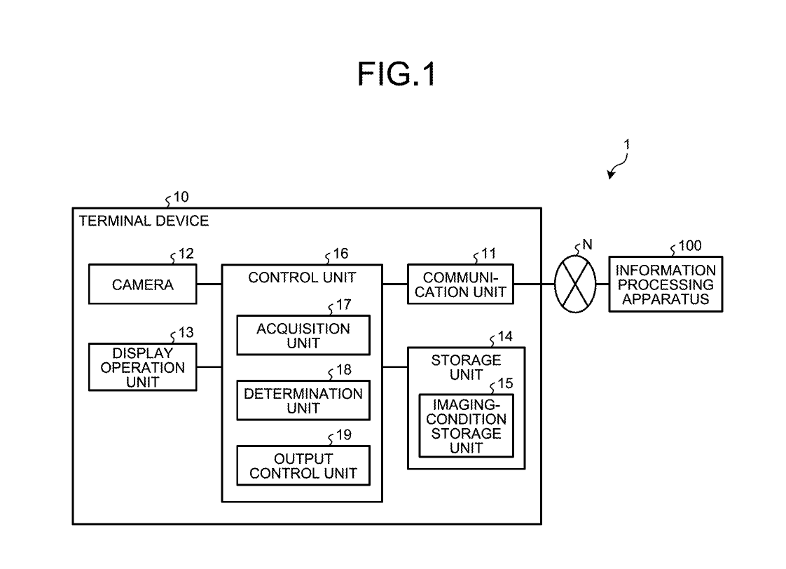

FIG. 1 is a block diagram illustrating an example of a configuration of an imaging control system according to an embodiment. An imaging control system 1 illustrated in FIG. 1 includes a terminal device 10 and an information processing apparatus 100. A case in which the imaging control system 1 includes one terminal device 10 and one information processing apparatus 100 is illustrated in FIG. 1. However, the number of terminal devices 10 and that of information processing apparatuses 100 are not limited thereto, and the imaging control system 1 can include an arbitrary number of terminal devices 10 and information processing apparatuses 100.

The terminal device 10 and the information processing apparatus 100 are connected with each other via a network N in a mutually communicable manner. An arbitrary type of communication network such as the Internet, a LAN (Local Area Network) or a VPN (Virtual Private Network) can be employed for the network N, regardless of being wired or wireless.

The imaging control system 1 is an example of a system that performs remote assistance such as issuing an instruction by sharing an image of a screen of the terminal device 10 between the terminal device 10 of a worker and the information processing apparatus 100 of an assistant, or remotely operating the terminal device 10. For example, the terminal device 10 is an information processing apparatus, which is carried together with an HMD by a worker who performs inspection to perform an inspection work while referring to operating instructions, manuals, or the like. Further, the terminal device 10 captures an image of, for example, a tag of a cable and transmits the image to the information processing apparatus 100.

The information processing apparatus 100 is used by an assistant who assists workers. The information processing apparatus 100 issues an instruction by sharing an image of a screen of the terminal device 10 between the terminal device 10 of a worker and the information processing apparatus 100, or remotely operating the terminal device 10. The information processing apparatus 100 receives and displays an image captured by the terminal device 10.

Upon detection that a reference object is included in a captured image taken by a camera, the terminal device 10 refers to a storage unit that stores therein imaging conditions in association with respective pieces of identification information of a plurality of reference objects, thereby acquiring the imaging conditions associated with the identification information of the detected reference object. The terminal device 10 determines whether the captured image taken by the camera satisfies the acquired imaging conditions. If the captured image satisfies the imaging conditions, the terminal device 10 outputs an instruction to the camera to capture another image that satisfies the imaging conditions. Due to this configuration, the terminal device 10 can reduce imaging workload.

A configuration of the terminal device 10 is described next. As illustrated in FIG. 1, the terminal device 10 includes a communication unit 11, a camera 12, a display operation unit 13, a storage unit 14, and a control unit 16. The terminal device 10 can also include, other than the functional units illustrated in FIG. 1, functional units such as various input devices or audio output devices.

The communication unit 11 is realized by, for example, a third-generation mobile communication system, a mobile telephone line such as LTE (Long Term Evolution), or a communication module such as a wireless LAN. The communication unit 11 is a communication interface wirelessly connected to the information processing apparatus 100 via the network N, to control communication of information with the information processing apparatus 100. The communication unit 11 transmits an extracted image input from the control unit 16 to the information processing apparatus 100. The communication unit 11 receives imaging condition information indicating the imaging conditions for each marker from a server (not illustrated). The communication unit 11 outputs the received imaging condition information to the control unit 16.

For example, the camera 12 is provided in the HMD carried by the worker, and captures an image of the front of the worker. The camera 12 captures an image, for example, by using a CMOS (Complementary Metal Oxide Semiconductor) image sensor or a CCD (Charge Coupled Device) image sensor as an imaging element. The camera 12 photoelectrically converts the light received by the imaging element and performs A/D (Analog/Digital) conversion to generate a captured image. The camera 12 outputs the generated captured image to the control unit 16.

When an activation instruction is input from the control unit 16, the camera 12 starts to output a preview image to the control unit 16. It is possible to configure that, when an activation instruction of a marker imaging mode is input from the control unit 16, the camera 12 activates the marker imaging mode and starts to output the preview image to the control unit 16. Further, when an imaging instruction is input from the control unit 16, the camera 12 captures an image at a resolution specified in the imaging instruction, and outputs the captured image to the control unit 16.

The display operation unit 13 is a display device for displaying various pieces of information, and is an input device that receives various operations from a worker as a user. For example, the display operation unit 13 is realized by a liquid crystal display as a display device. Further, for example, the display operation unit 13 is also realized by a touch panel or the like as the input device. That is, the display operation unit 13 is realized by integrating the display device and the input device. The display operation unit 13 outputs an operation input by the worker to the control unit 16 as operating information.

The storage unit 14 is realized by, for example, a semiconductor memory device such as a RAM (Random Access Memory) or a flash memory, or a storage device such as a hard disk or an optical disk. The storage unit 14 includes an imaging-condition storage unit 15. The storage unit 14 stores therein information to be used for the processing by the control unit 16.

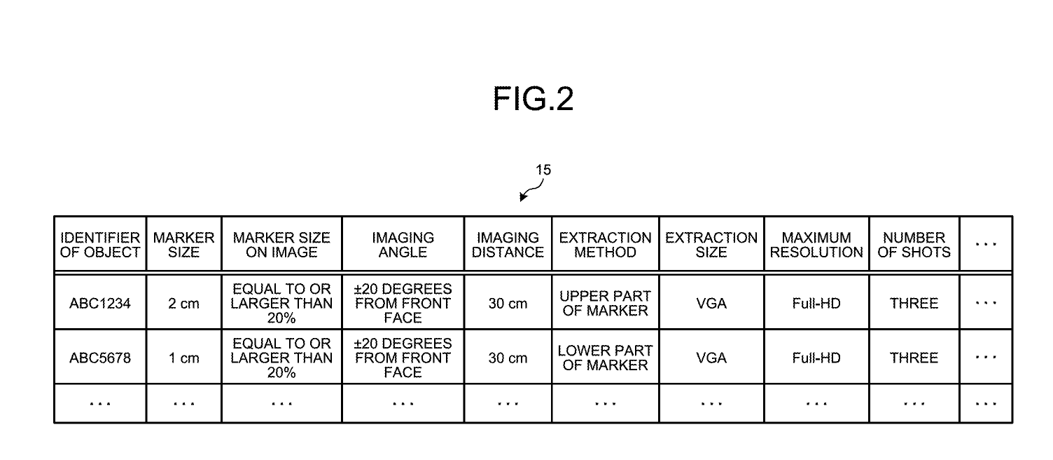

The imaging-condition storage unit 15 stores therein imaging condition information received by a server (not illustrated), that is, imaging conditions for each marker. That is, the imaging-condition storage unit 15 is an example of a storage unit that stores therein imaging conditions in association with the respective pieces of identification information of the respective reference objects. FIG. 2 is a diagram illustrating an example of the imaging-condition storage unit. As illustrated in FIG. 2, the imaging-condition storage unit 15 includes items of “identifier of object”, “marker size”, “marker size on image”, “imaging angle”, “imaging distance”, “extraction method”, “extraction size”, “maximum resolution”, and “number of shots”. For example, the imaging-condition storage unit 15 stores therein the imaging conditions for each identifier of the object as one record.

The “identifier of object” is an identifier to identify an object such as a cable. The “identifier of object” is associated with the reference object, that is, a marker ID (IDentifier) to identify a marker for each object. In the present embodiment, it is described that the marker ID is set to be the same as the identifier of the object. However, the marker ID and the identifier of the object can be different from each other. The “marker size” is information indicating the size of a marker being an example of the reference object. For example, an AR (Augmented Reality) marker can be used as the marker. The “marker size” can be, for example, 1-centimeter square or 2-centimeter square.

The “marker size on screen” is information indicating the size of the marker on the preview image. For example, the “marker size on screen” is set such that if the size is equal to or larger than 20% of the length of the image in a vertical direction or a horizontal direction, the size is appropriate. The “marker size on screen” can be expressed by a fraction, for example, “⅕”, designating the length of the image in the vertical direction or the horizontal direction as “1”, other than percentage. The “imaging angle” is information indicating an inclination from the front face of the marker. The “imaging angle” is set as appropriate, if the imaging angle is within a range of ±20 degrees vertically and horizontally from the front face of the marker. The “imaging distance” is information indicating an imaging distance capable of recognizing the marker. The “imaging distance” can be set as 30 centimeters, if the marker size is, for example, 1-centimeter square or 2-centimeter square. That is, in the present embodiment, for example, if the imaging distance is 1 meter, the marker is not brought into focus and thus the marker is not able to be recognized. If the imaging distance is 30 centimeters, the marker is brought into focus, and the marker can be recognized.

The “extraction method” is information indicating a method of specifying a range of an image to be extracted from a preview image by using a marker as a reference. The “extraction method” is a method of specifying, for example, an upper part of the marker or a lower part of the marker. The “extraction size” is information indicating the size of an image to be extracted from the preview image. The “maximum resolution” is information indicating the maximum resolution of the camera 12. The “maximum resolution” is not limited to the maximum resolution of the camera 12, and an arbitrary resolution can be set. That is, the “maximum resolution” is setting information of a specified resolution with respect to the camera 12. The “number of shots” is information indicating the number of images of the object to be imaged. The “imaging conditions” can be acquired from a server (not illustrated) in advance, or the imaging conditions corresponding to the marker can be acquired from the server after the marker is recognized.

Returning to the description of FIG. 1, the control unit 16 is realized by, for example, a CPU (Central Processing Unit) or an MPU (Micro Processing Unit) that executes a program stored in the internal storage device by using the RAM as a work area. Further, the control unit 16 can be realized by, for example, an integrated circuit such as an ASIC (Application Specific Integrated Circuit) or an FPGA (Field Programmable Gate Array). The control unit 16 includes an acquisition unit 17, a determination unit 18, and an output control unit 19 to realize or perform functions or operations of information processing described later. The internal configuration of the control unit 16 is not limited to the configuration illustrated in FIG. 1, and another configuration can be used so long as it is a configuration to perform the information processing described later. When the imaging condition information is input from the communication unit 11, the control unit 16 stores the input imaging condition information in the imaging-condition storage unit 15.

When activation of the camera 12 is instructed by, for example, a worker, the acquisition unit 17 outputs an activation instruction to the camera 12. The acquisition unit 17 acquires a preview image, whose output is started in response to the activation instruction from the camera 12. After activating the camera 12, the acquisition unit 17 can output an activation instruction of the marker imaging mode to the camera 12 by the operation of the worker, and then can start to acquire the preview image. The acquisition unit 17 performs a marker detection process with respect to the acquired preview image. That is, the acquisition unit 17 determines whether the marker has been detected in the preview image. When the marker is not detected, the acquisition unit 17 continues to acquire the preview image.

When having detected a marker, the acquisition unit 17 refers to the imaging-condition storage unit 15 to determine whether the detected marker has been registered therein. If the detected marker has not been registered, the acquisition unit 17 continues to acquire the preview image. If the detected marker has been registered, the acquisition unit 17 refers to the imaging-condition storage unit 15 to acquire the imaging conditions associated with the detected marker, that is, the identifier of the object. That is, when having detected that the reference object is included in the captured image taken by the camera 12, the acquisition unit 17 refers to the imaging-condition storage unit 15 to acquire the imaging conditions associated with the identification information of the detected reference object. The acquisition unit 17 outputs the preview image and the acquired imaging conditions to the determination unit 18.

When a preview image and imaging conditions are input from the acquisition unit 17, the determination unit 18 determines whether the preview image satisfies the imaging conditions. That is, the determination unit 18 determines whether the captured image taken by the camera 12 satisfies the acquired imaging conditions. Specifically, the determination unit 18 first determines whether the marker size on the preview image is appropriate. If the marker size is not appropriate, the determination unit 18 instructs the acquisition unit 17 to continue to acquire the preview image. If the marker size is appropriate, the determination unit 18 determines whether the imaging angle is appropriate based on distortion of the marker on the preview image. If the imaging angle is not appropriate, the determination unit 18 instructs the acquisition unit 17 to continue to acquire the preview image.

If the imaging angle is appropriate, the determination unit 18 determines whether the object imaged in the preview image and the identifier of the object corresponding to the detected marker match each other. For example, the determination unit 18 recognizes the color and thickness of the cable being the object with respect to the preview image, and determines whether the combination of the recognized color and thickness of the cable and the combination of the color and thickness of the cable indicated by the identifier of the object match each other. If the object and the identifier of the object do not match each other, the determination unit 18 instructs the acquisition unit 17 to continue to acquire the preview image. If the object and the identifier of the object match each other, the determination unit 18 outputs the imaging conditions and the imaging instruction to the output control unit 19.

If the captured image taken by the camera 12 does not satisfy the acquired imaging conditions, the determination unit 18 can output guide information to the output control unit 19 so as to satisfy the imaging conditions, and can cause the display operation unit 13 to display the guide information via the output control unit 19. In this case, the worker can easily move the camera 12 to a position satisfying the imaging conditions by adjusting the distance between the camera 12 and the object and the direction, while checking the guide information. That is, the terminal device 10 can further reduce the imaging workload regarding imaging of the object.

When the number of captured images is input from the output control unit 19, the determination unit 18 determines whether the number of captured images satisfies the number of shots. If the number of captured images does not satisfy the number of shots, the determination unit 18 instructs the acquisition unit 17 to continue to acquire the preview image. If the number of captured images satisfies the number of shots, the determination unit 18 outputs a transmission instruction to the output control unit 19.

When the imaging conditions and the imaging instruction are input from the determination unit 18, the output control unit 19 outputs the imaging instruction to the camera 12 to capture an image at a specified resolution, for example, at the maximum resolution in the imaging conditions. That is, if the imaging conditions are satisfied, the output control unit 19 outputs an instruction to the camera 12 to capture an image that satisfies the imaging conditions. The output control unit 19 outputs an instruction to the camera 12, for example, to capture an image that has higher image quality than that of the captured image, as the imaging instruction. For example, when the preview image has a VGA (Video Graphics Array) size, the output control unit 19 outputs an imaging instruction to the camera 12 to capture an image having a Full-HD size.

When the captured image according to the imaging instruction is input from the camera 12, the output control unit 19 extracts an image having an extraction size from the captured image according to the extraction method in the imaging conditions. The output control unit 19 temporarily stores the extracted image in the storage unit 14 as an extracted image. The output control unit 19 sets the number of captured images indicating how many images have been taken with respect to the number of shots included in the imaging conditions. The output control unit 19 outputs the set number of captured images to the determination unit 18.

When a transmission instruction is input from the determination unit 18, the output control unit 19 transmits the extracted image temporarily stored in the storage unit 14 to the information processing apparatus 100 via the communication unit 11 and the network N. When having transmitted the extracted image to the information processing apparatus 100, the output control unit 19 determines whether an instruction to stop the camera 12 has been received from the worker. If the instruction to stop the camera 12 has not been received, the output control unit 19 instructs the acquisition unit 17 to continue to acquire the preview image. If the instruction to stop the camera 12 has been received, the output control unit 19 finishes an imaging control process.

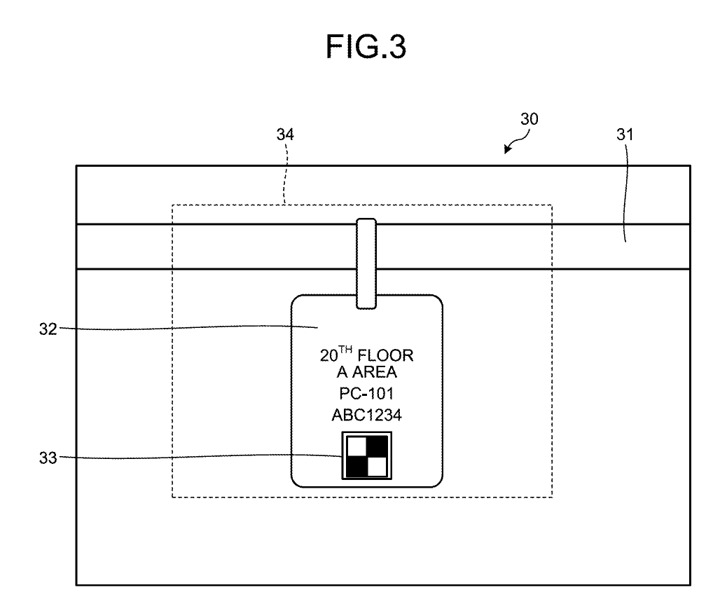

An extraction range of a captured image is described here with reference to FIG. 3. FIG. 3 is a diagram illustrating an example of an extraction range of a captured image. As illustrated in FIG. 3, a captured image 30 has a specified resolution, for example, has a Full-HD size, and is an image captured according to an imaging instruction from the output control unit 19. The captured image 30 includes a cable 31 being an object, and a tag 32 of the cable 31. A marker 33 is attached to the tag 32. The marker 33 can be attached to the tag 32 in advance, or the worker can bring the marker 33 and attach the marker 33 to the tag 32.

The output control unit 19 extracts an extracted image 34 with an extraction size “VGA”, for example, according to an extraction method “upper part of marker” in the imaging conditions. That is, regarding the marker 33 detected on a preview image, if the imaging conditions associated with the identification information (a marker ID or an identifier of the object) of the marker 33 are satisfied, the terminal device 10 captures the captured image 30 having a higher resolution than the preview image satisfying the imaging conditions. The terminal device 10 extracts the extracted image 34 in the specified extraction size by the specified extraction method from the captured image 30 based on the position of the marker 33.

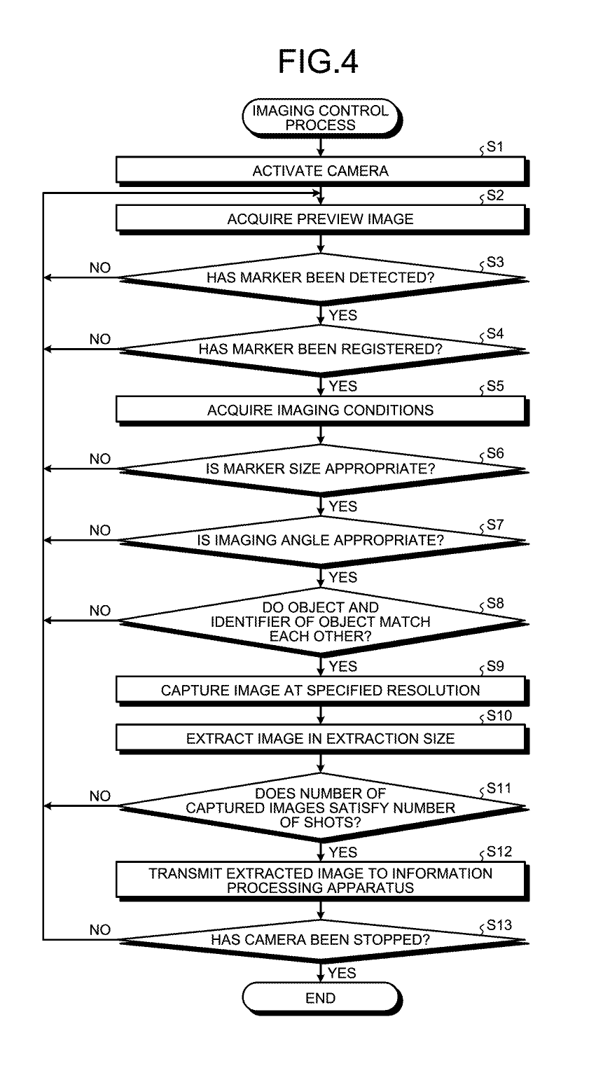

An operation of the imaging control system 1 according to the embodiment is described next. FIG. 4 is a flowchart illustrating an example of the imaging control process according to the present embodiment.

When activation of the camera 12 is instructed, the acquisition unit 17 of the terminal device 10 outputs an activation instruction to the camera 12. When the activation instruction is input from the acquisition unit 17 of the control unit 16, the camera 12 is activated to start output of a preview image to the acquisition unit 17 of the control unit 16 (Step S1). The acquisition unit 17 acquires the preview image whose output has been started from the camera 12 according to the activation instruction (Step S2).

The acquisition unit 17 determines whether a marker has been detected with respect to the preview image (Step S3). If the marker has not been detected (NO at Step S3), the acquisition unit 17 returns to Step S2. If the marker has been detected (YES at Step S3), the acquisition unit 17 refers to the imaging-condition storage unit 15 to determine whether the detected marker has been registered (Step S4). If the detected marker has not been registered (NO at Step S4), the acquisition unit 17 returns to Step S2. If the detected marker has been registered (YES at Step S4), the acquisition unit 17 refers to the imaging-condition storage unit 15 to acquire imaging conditions associated with the detected marker (Step S5). The acquisition unit 17 outputs the preview image and the acquired imaging conditions to the determination unit 18.

When the preview image and the imaging conditions are input from the acquisition unit 17, the determination unit 18 determines whether the marker size on the preview image is appropriate (Step S6). If the marker size is not appropriate (NO at Step S6), the determination unit 18 returns to Step S2. If the marker size is appropriate (YES at Step S6), the determination unit 18 determines whether the imaging angle is appropriate (Step S7). If the imaging angle is not appropriate (NO at Step S7), the determination unit 18 returns to Step S2.

If the imaging angle is appropriate (YES at Step S7), the determination unit 18 determines whether an object and an identifier of the object match each other (Step S8). If the object and the identifier of the object do not match each other (NO at Step S8), the determination unit 18 returns to Step S2. If the object and the identifier of the object match each other (YES at Step S8), the determination unit 18 outputs the imaging conditions and the imaging instruction to the output control unit 19.

When the imaging conditions and the imaging instruction are input from the determination unit 18, the output control unit 19 outputs the imaging instruction to the camera 12 to capture an image at a specified resolution. When the imaging instruction is input from the output control unit 19 of the control unit 16, the camera 12 captures an image at the specified resolution in the imaging instruction (Step S9), and outputs the captured image to the output control unit 19 of the control unit 16.

When the captured image according to the imaging instruction is input from the camera 12, the output control unit 19 extracts an image in the extraction size from the captured image according to the extraction method in the imaging conditions (Step S10). The output control unit 19 temporarily stores the extracted image in the storage unit 14 as an extracted image. The output control unit 19 sets the number of captured images, and outputs the set number of captured images to the determination unit 18.

When the number of captured images is input from the output control unit 19, the determination unit 18 determines whether the number of captured images satisfy the number of shots (YES at Step S11). If the number of captured images does not satisfy the number of shots (NO at Step S11), the determination unit 18 returns to Step S2. If the number of captured images satisfy the number of shots (YES at Step S11), the determination unit 18 outputs a transmission instruction to the output control unit 19.

When the transmission instruction is input from the determination unit 18, the output control unit 19 transmits the extracted image temporarily stored in the storage unit 14 to the information processing apparatus 100 (Step S12). Upon transmission of the extracted image to the information processing apparatus 100, the output control unit 19 determines whether an instruction to stop the camera 12 has been received from a worker (Step S13). If the instruction to stop the camera 12 has not been received (NO at Step S13), the output control unit 19 returns to Step S2. If the instruction to stop the camera 12 has been received (YES at Step S13), the output control unit 19 finishes the imaging control process. Due to this process, the terminal device 10 can reduce the imaging workload.

Because the terminal device 10 approaches the object to capture an image by reducing the size of the marker, the image of the object can be captured without blurring. The terminal device 10 can capture the object by recognizing the marker. Because the terminal device 10 automatically captures an image when the imaging conditions are satisfied, and transmits an extracted image extracted from the captured image to the information processing apparatus 100 of an assistant, the on-site worker and the assistant can easily recognize the image without any workload.

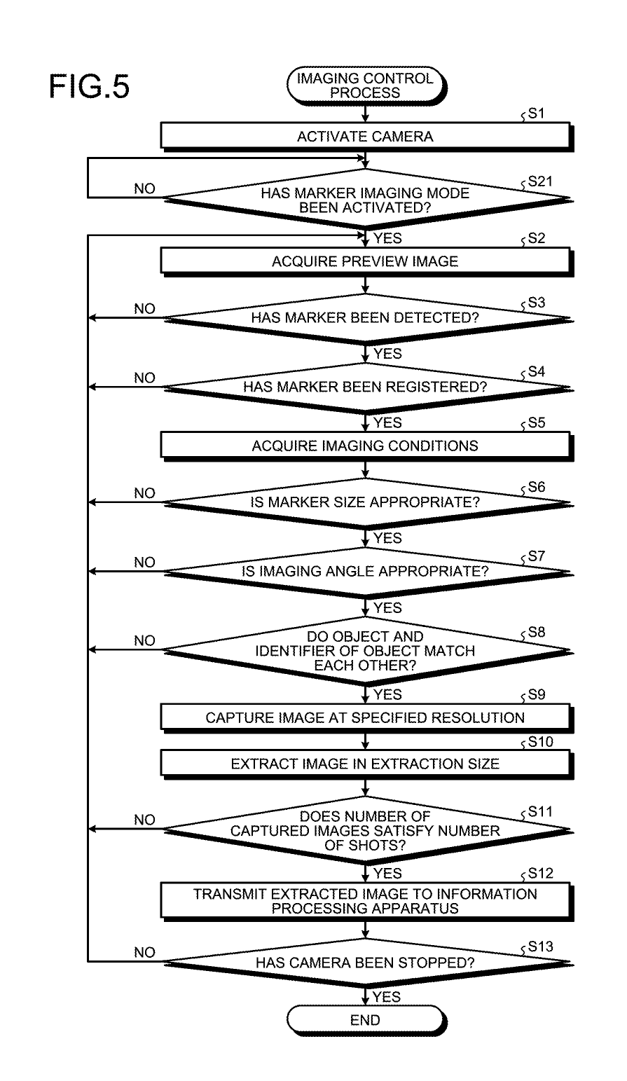

To further suppress power consumption, a recognition process of the marker can be started by an instruction of the worker, and the imaging control process in this case is described with reference to FIG. 5. Like reference signs refer to like processes in the imaging control process in FIG. 4, and descriptions of redundant operations are omitted. FIG. 5 is a flowchart illustrating an example of the imaging control process according to the present embodiment.

When the camera 12 is activated at Step S1, the acquisition unit 17 of the terminal device 10 determines whether a marker imaging mode is to be activated based on an input operation from a worker (Step S21). If the marker imaging mode is not to be activated (NO at Step S21), the determination unit 18 repeats determination at Step S21. If the marker imaging mode is to be activated (YES at Step S21), the acquisition unit 17 outputs an activation instruction of the marker imaging mode to the camera 12. When output of the preview image is started from the camera 12 in response to the activation instruction of the marker imaging mode, the acquisition unit 17 proceeds to Step S2 to acquire the preview image. Due to this process, the terminal device 10 can reduce the imaging workload while suppressing the power consumption.

In this manner, the terminal device 10 includes the imaging-condition storage unit 15 that stores the imaging conditions in association with respective pieces of identification information of the respective reference objects. When having detected that the reference object is included in the captured image taken by the camera 12, the terminal device 10 refers to the imaging-condition storage unit 15 to acquire the imaging conditions associated with the identification information of the detected reference object. Further, the terminal device 10 determines whether the captured image taken by the camera 12 satisfies the acquired imaging conditions. If the imaging conditions are satisfied, the terminal device 10 outputs an instruction to the camera 12 to capture another image satisfying the imaging conditions. As a result, the imaging workload can be reduced.

Further, the terminal device 10 outputs an instruction to the camera 12 to capture an image having higher image quality than that of the captured image. As a result, with regard to a desired object, an image having higher image quality can be transmitted to the information processing apparatus 100 of the assistant.

In the terminal device 10, the imaging conditions include the imaging angle of the camera 12 with respect to a reference object. As a result, an image in which the tag information is easily readable can be acquired.

In the terminal device 10, the imaging conditions include the imaging distance of the camera 12 from a reference object. As a result, an image in which the tag information is easily readable can be acquired.

In the terminal device 10, the imaging conditions include the position of the reference object in the captured image. As a result, an image in which the tag information is easily readable can be acquired.

In the terminal device 10, the imaging conditions include setting information of the resolution of the camera 12. As a result, an image in which the tag information is easily readable can be acquired.

In the terminal device 10, the imaging conditions include an identifier of an object associated with a reference object. As a result, the object can be identified.

If the imaging conditions are not satisfied, the terminal device 10 outputs guide information so as to satisfy the imaging conditions. As a result, the imaging workload can be further reduced with regard to imaging of the object.

In the embodiment described above, an extracted image is transmitted from the terminal device 10 of one worker to the information processing apparatus 100 of one assistant. However, the present invention is not limited thereto. For example, the extracted image can be transmitted from the terminal device 10 of one worker to the information processing apparatuses 100 of a plurality of assistants. Further, the extracted image can be transmitted from the terminal devices 10 of a plurality of workers to the information processing apparatus 100 of one assistant. The extracted image can be also transmitted from the terminal devices 10 of a plurality of workers to the information processing apparatuses 100 of a plurality of assistants.

In the embodiment described above, a tag is attached to a cable as an object and a marker of the tag is recognized, so as to acquire the imaging conditions. However, the present invention is not limited thereto. For example, if an object has an object recognizable feature in its shape or the like, object recognition can be used instead of marker recognition.

It is not always needed that respective constituent elements of respective units illustrated in the drawings are configured physically as illustrated. That is, the specific mode of distribution and integration of the respective units is not limited to the illustrated ones, and all or a part thereof can be functionally or physically distributed or integrated in an arbitrary unit according to various kinds of loads, the use status, and the like. For example, the determination unit 18 and the output control unit 19 can be integrated with each other. The order of respective processes illustrated in the drawings is not limited to the order described above, and these processes can be performed simultaneously or in different orders within a scope in which processing contents of the respective processes do not contradict with one another.

Further, as for the respective processing functions executed in the respective devices, an arbitrary part or all of these functions can be executed on a CPU (or a microcomputer such as an MPU or an MCU (Micro Controller Unit)). It is needless to mention that an arbitrary part or all of the respective processing functions can be executed on a program analyzed and executed by a CPU (or a microcomputer such as an MPU or an MCU) or on hardware by a wired logic.

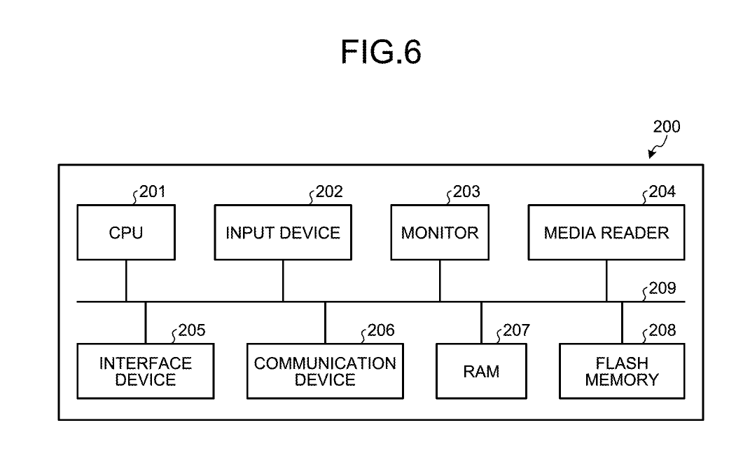

Various processes described in the above embodiment can be realized by executing a program prepared in advance by a computer. Therefore, an example of the computer that executes a program having the same functions as those of the above embodiment is described here. FIG. 6 is a diagram illustrating an example of a computer that executes an imaging control program.

As illustrated in FIG. 6, a computer 200 includes a CPU 201 that performs various arithmetic processes, an input device 202 that receives data input, and a monitor 203. The computer 200 also includes a media reader 204 that reads a program or the like from a recording medium, an interface device 205 for connecting with various devices, and a communication device 206 that connects the computer 200 with another information processing apparatus or the like by wired or wireless connection. The computer 200 also includes a RAM 207 and a flash memory 208 to temporarily store therein various pieces of information. The respective devices 201 to 208 are connected to a bus 209.

The imaging control program having the same functions as those of the respective processing units of the acquisition unit 17, the determination unit 18, and the output control unit 19 illustrated in FIG. 1 is stored in the flash memory 208. Various pieces of data to realize the imaging-condition storage unit 15 and the imaging control program are also stored in the flash memory 208. The input device 202 has the same function, for example, as the display operation unit 13 illustrated in FIG. 1, and receives input of various pieces of information such as the operating information from a user of the computer 200. The monitor 203 has the same function, for example, as the display operation unit 13 illustrated in FIG. 1, and displays various screens such as a display screen with respect to the user of the computer 200. The interface device 205 is connected to, for example, an HMD. The communication device 206 has the same function, for example, as the communication unit 11 illustrated in FIG. 11, and is connected to the information processing apparatus 100 to transmit and receive various pieces of information to and from the information processing apparatus 100.

The CPU 201 reads out the respective programs stored in the flash memory 208, loads the read program in the RAM 207, and executes the respective programs, thereby performing various processes. These programs can cause the computer 200 to function as the acquisition unit 17, the determination unit 18, and the output control unit 19 illustrated in FIG. 1.

The imaging control program described above does not always need to be stored in the flash memory 208. For example, it is also possible to configure that a program stored in a storage medium readable by the computer 200 is read and executed by the computer 200. The storage medium readable by the computer 200 corresponds to a portable storage medium such as a CD-ROM, a DVD disk, and a USB (Universal Serial Bus) memory, a semiconductor memory such as a flash memory, and a hard disk drive. Further, it is also possible to configure that the imaging control program is stored in a device being connected to a public line, the Internet, a LAN, and the like, and the computer 200 reads the imaging control program from such a network and executes the program.

According to the present invention, the imaging workload can be reduced.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein an imaging control program that causes a computer to execute a process comprising:
acquiring imaging condition, upon detection that a reference object is included in a captured image taken by a camera, the imaging condition being associated with identification information of the detected reference object by referring to a storage that stores a plurality of imaging conditions in association with pieces of identification information of a plurality of reference objects respectively;
determining whether the captured image is corresponding to the acquired imaging condition; and
outputting, when the imaging condition is corresponding to the acquired imaging condition, an instruction to the camera to capture another image.

2. The non-transitory computer-readable recording medium according to claim 1, wherein the outputting includes outputting an instruction to the camera to capture an image having higher image quality than image quality of the captured image.

3. The non-transitory computer-readable recording medium according to claim 1, wherein the imaging conditions include an imaging angle of the camera with respect to the reference object.

4. The non-transitory computer-readable recording medium according to claim 1, wherein the imaging conditions include an imaging distance of the camera with respect to the reference object.

5. The non-transitory computer-readable recording medium according to claim 1, wherein the imaging conditions include a position of the reference object in the captured image.

6. The non-transitory computer-readable recording medium according to claim 1, wherein the imaging conditions include setting information of a resolution of the camera.

7. The non-transitory computer-readable recording medium according to claim 1, wherein the imaging conditions include an identifier of an object associated with the reference object.

8. The non-transitory computer-readable recording medium according to claim 1, wherein, when the imaging conditions are not satisfied, the outputting is to output guide information so as to satisfy the imaging conditions.

9. An imaging control method implemented by a computer, the imaging control method comprising:
acquiring imaging condition, upon detection that a reference object is included in a captured image taken by a camera, the imaging condition being associated with identification information of the detected reference object by referring to a storage that stores a plurality of imaging conditions in association with pieces of identification information of a plurality of reference objects respectively, using a processor;
determining whether the captured image is corresponding to the acquired imaging condition, using the processor; and
outputting, when the imaging condition is corresponding to the acquired imaging condition, an instruction to the camera to capture another image, using the processor.

10. The imaging control method according to claim 9, wherein the outputting includes outputting an instruction to the camera to capture an image having higher image quality than image quality of the captured image.

11. The imaging control method according to claim 9, wherein the imaging conditions include an imaging angle of the camera with respect to the reference object.

12. The imaging control method according to claim 9, wherein the imaging conditions include an imaging distance of the camera with respect to the reference object.

13. The imaging control method according to claim 9, wherein the imaging conditions include a position of the reference object in the captured image.

14. The imaging control method according to claim 9, wherein the imaging conditions include setting information of a resolution of the camera.

15. The imaging control method according to claim 9, wherein the imaging conditions include an identifier of an object associated with the reference object.

16. The imaging control method according to claim 9, wherein, when the imaging conditions are not satisfied, the outputting is to output guide information so as to satisfy the imaging conditions.

17. An information processing apparatus comprising:
a memory; and
a processor coupled to the memory, wherein the processor executes a process comprising:
acquiring imaging conditions, upon detection that a reference object is included in a captured image taken by a camera, the imaging condition being associated with identification information of the detected reference object by referring to a storage that stores a plurality of imaging conditions in association with pieces of identification information of a plurality of reference objects respectively;
determining whether the captured image is corresponding to the acquired imaging condition; and
outputting, when the imaging condition is corresponding to the acquired imaging condition, an instruction to the camera to capture another image.

18. The information processing apparatus according to claim 17, wherein the outputting includes outputting an instruction to the camera to capture an image having higher image quality than image quality of the captured image.

19. The information processing apparatus according to claim 17, wherein the imaging conditions include an imaging angle of the camera with respect to the reference object.

20. The information processing apparatus according to claim 17, wherein the imaging conditions include an imaging distance of the camera with respect to the reference object.

21. The information processing apparatus according to claim 17, wherein the imaging conditions include a position of the reference object in the captured image.

22. The information processing apparatus according to claim 17, wherein the imaging conditions include setting information of a resolution of the camera.

23. The information processing apparatus according to claim 17, wherein the imaging conditions include an identifier of an object associated with the reference object.

24. The information processing apparatus according to claim 17, wherein, when the imaging conditions are not satisfied, the outputting is to output guide information so as to satisfy the imaging conditions.
